(19) United States
(12) Patent Application Publication
(10) Pub. No.: US 2016/0042227 A1
(43) Pub. Date: Feb. 11, 2016

(54) SYSTEM AND METHOD FOR DETERMINING VIEW INVARIANT SPATIAL-TEMPORAL DESCRIPTORS FOR MOTION DETECTION AND ANALYSIS

(71) Applicant: BAE Systems Information and Electronic Systems Integraton Inc., Nashua, NH (US)

(72) Inventor: Yu Zhong, Winchester, MA (US)

(21) Appl. No.: 14/809,989

(22) Filed: Jul. 27, 2015

Related U.S. Application Data
(60) Provisional application No. 62/033,920, filed on Aug. 6, 2014.

(51) Int. Cl. G06K 9/00; G06K 9/62; G06T 7/20; G06T 7/00

(52) U.S. Cl. CPC G06K 9/00342; G06T 7/0071; G06K 9/6215; G06T 7/20

(57) ABSTRACT

A method and system for determining view invariant spatial-temporal descriptors encoding details of both motion dynamics and posture interactions that are highly representative and discriminative. The method and system describe determining posture interactions descriptors and motion dynamics descriptors by utilizing cosine similarity approach thereby rendering the descriptors to be view invariant.

This application claims priority to provisional U.S. Application No. 62/033,920, filed on Aug. 6, 2014. The content of the above application is incorporated by reference in its entirety.

### FIELD OF THE DISCLOSURE

The presently disclosed embodiments are generally related to human motion analysis, and more particularly to human motion analysis using 3D depth sensors or other motion capture devices.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Action and activity recognition has long been an area of keen interest in computer vision research for intelligent interaction between machines and humans. Yet this area has remained a major challenge due to the difficulties in accurate recovery and interpretation of motion from degenerated and noisy 2D images and video. In practice, the presence of variations in viewing geometry, background clutter, varying appearances, uncontrolled lighting conditions, and low image resolutions further complicates the problem. 3D depth images directly measure the 3D structures to provide more accurate motion estimates that are advantageous for action analysis, but this data has not been readily available in real-world applications due to the high cost of traditional 3D sensors. The launch of Kinect™ sensors for Xbox™ by Microsoft, which capture decent depth image streams at a tiny fraction of the cost of conventional range scanners, has created a surge of research interest in action recognition and activity analysis with many potential real world applications including human/computer interaction, content based video retrieval, health monitoring, athletic performance analysis, security and surveillance, gaming and entertainment, and the like.

Psychological studies have shown that human observers can instantly recognize actions from the motion patterns of a few dots affixed on a human body, indicating the sufficiency of joint movements in motion recognition without additional structural recovery. In principle, joint motion representation exhibits much fewer variations than commonly used appearance features, making it an appealing input candidate for real-world action recognition applications. A recent experimental comparison study on pose-based and appearance-based action recognition suggests that pose estimation is advantageous and pose-based features outperform low level appearance features for action recognition. However, research on this topic has until recently been scarce due to the difficulty in extracting accurate poses or skeletons from images and video. With the recent breakthrough in real-time pose estimation using 3D depth image sequences, joints can he tracked with reasonable accuracy using collected depth images making it possible for accurate action and activity recognition using the tracked skeletons.

Earlier works on action recognition are mainly based on 2D image sequences or video as disclosed in J. Liu, S. Ali, and M. Shah, “Recognizing Human Actions Using Multiple Features”, CVPR'08, A. Yilmax and M. Shah, Actions sketch: “A Novel Action Representation”, CVPR'05, Vol 1, pp: 984-989, and L. Zelnik-Manor and M. Irani, “Statistical Analysis of Dynamic Actions”, IEEE Trans. PAMI 28(9): 1530-1535, 2006. One of the prevailing approaches is to match actions as shapes in the 3D volume of space and time. Spatial-temporal descriptors have been extracted to effectively encode local motion characteristics with great success. In addition, spatial-temporal, context information can be modelled using transition matrices of Markov processes.

Since the introduction of Kinect™ RGB-depth sensor in 2010, there has been a surge of research exploiting Kinect™ depth images and tracked skeletons for action recognition. Some of the approaches extract features using the surface points or surface normal estimated from depth images. Histograms of Oriented Gradient (HOG) computed from the depth or RGB images have been used to encode motion or appearance patterns. Variants such as histograms of 4D normal orientations have also been exploited for action analysis. Other published works take advantage of tracked skeletons to recognize human actions and activities. Yang and Tian proposed an EigenJoints representation computed from the relative offsets of joint positions as described in X. Yang and Y. Tian. “Effective3D Action Recognition Using EigenJoints.” Journal of Visual Communication and Image Representation, 2013. Xia et al learned posture visual words from histograms of 3D joint locations, and modelled the temporal evolutions using discrete hidden Markov models L as is disclosed in Xia, C. Chen, and J. K. Aggarwal view “Invariant Human Action Recognition Using Histograms of 3D joints: in Computer Vision and Pattern Recognition Workshops (CVPRW), 2012 IEEE Computer Society Conference IEEE, 2012. Ohn-Bar and Trivedi characterized an action using the pairwise affinity matrix of joint angle trajectories over the entire duration of the action in view “Invariant Human Action Recognition Using Histograms of 3D Joints. ” Computer Vision and Pattern Recognition Workshops (CVPRW), 2012 IEEE Computer Society Conference IEEE, 2012. Chaudhry et al. proposed to use a linear dynamic system representation of a hierarchy of multi-scale dynamic medial axis structures to represent skeletal action sequence in R. Chaudhry, F. Ofli, G. Kuriilo, R. Bajcsy, and R. Vidal, “Bio-Inspired Dynamic 3D Discriminative Skeletal Features for Human Action Recognition.” CVPRW, 2013. Distances from joints to planes spanned by joints are used in A. Yao, J. Gall, G. Fanelli and L. V. Gool. “Does Human Action Recognition Benefit From Pose Estimation?” Proc. BMVC 2011 and disclosed also in K. Yun, J. Honorio, D. Chattopadhyay, T. L. Berg, and D. Samaras, “Two-Person Interaction Detection Using Body-Pose Features and Multiple Instance Learning.” In Computer Vision and Pattern Recognition Workshops (CVPRW). 2012 IEEE Computer Society Conference, pp. 28-35. IEEE, 2012. Joint features have also been combined with additional structure or appearance features to boost recognition performance. An actionlet ensemble consisting of relative joint position and local, occupancy patterns is disclosed in J. Wang, Z. Liu, Y. Wu, and J. Yuan, “Mining Actionlet Ensemble For Action Recognition With Depth Cameras.” In Computer Vision and Pattern Recognition (CVPR), 2012.

A need, however still exists for an improved way to conduct accurate motion analysis from 3D depth data, with applications for action/activity analysis, gait biometrics. Military and defense applications include standoff biometrics, security surveillance/threat detection, human/computer interaction, content based video retrieval, health monitoring, athletic performance analysis, gaming and entertainment, and the like.

### BRIEF SUMMARY

It will be understood that this disclosure in not limited to the particular systems, and methodologies described, as there can be multiple possible embodiments of the present disclosure which are not expressly illustrated in the present disclosure. it is also to be understood that the terminology used in the description is for the purpose of describing the particular versions or embodiments only, and is not intended to limit the scope of the present disclosure.

In an embodiment, a method for determining view invariant spatial-temporal descriptors, wherein the method comprises of retrieving location or motion information related to a plurality of joints over a time period, wherein at least a pair of joints amongst the plurality of joints constitute a limb; and determining posture interactions descriptors and motion dynamics descriptors, wherein the posture interactions descriptors are determined based on cosine similarities between one or more limbs, and the motion dynamics descriptors is determined based on cosine similarities between movements of the plurality of joints.

In another embodiment, a system for determining view invariant spatial-temporal descriptors comprising a location or motion acquisition module for retrieving location or motion information related to a plurality of joints over a time period, wherein at least a pair of joints amongst the plurality of joints constitute a limb; at least one processor; and a memory comprising one or more modules adapted to be executed by the at least one processor, wherein the processor upon executing the modules is configured for determining posture interactions descriptors and motion dynamics descriptors for the location or motion information retrieved by the location or motion acquisition module, wherein the posture interactions descriptors are determined based on cosine similarities between one or more limbs, and the motion dynamics descriptors is determined based on cosine similarities between movements of the plurality of joints.

It is an object of the present disclosure to determine descriptors that encode the fine spatial motion dynamics and posture interactions in a local temporal span of an entity such as a human being or a robot. Such descriptors may be applied for action detection or segmentation in addition to action recognition.

It is another object of the present disclosure to provide novel view invariant spatial-temporal descriptors for skeleton based action and activity recognition, and gait biometrics. These descriptors encode fine details of both motion dynamics and posture interactions, allowing them to be highly representative and discriminative.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The accompanying drawings illustrate various embodiments of systems, methods, and embodiments, of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa, furthermore, elements may not be drawn to scale. Non-limiting and non-exhaustive descriptions are described with reference to the following drawings. The components in the figures are not necessarily to scale, emphasis instead being placed upon illustrating principles.

FIG. 1a and FIG. 1b illustrates a skeleton tracked using a depth sensing device for sensing a tennis swing action.

FIG. 2 is a schematic drawing showing invariant spatial temporal interactions of a tracked skeleton over multiple frames.

FIG. 3 shows a flow diagram of a method for determining view invariant spatial-temporal posture interaction descriptors, according to an embodiment.

FIG. 4 shows a flow diagram of a method for determining view invariant spatial-temporal motion dynamics descriptors, according to an embodiment.

FIG. 5 illustrates a block diagram of a system for determining view invariant spatial-temporal descriptors, according to an embodiment.

FIG. 6 is a visualization of the motion dynamics descriptors and posture interaction descriptors for skeleton action sequences from the Microsoft Research Action3D dataset.

FIG. 7 is a graph showing a cross-subject action recognition accuracy of the proposed algorithm on the Microsoft Research Action3D dataset.

FIG. 8 illustrates confusion matrices for the three cross-subject action recognition tests on the Microsoft Research Action3D dataset.

### DETAILED DESCRIPTION

Some embodiments of this disclosure, illustrating all its features, will now be discussed in detail. The words “comprising,” “having,” “containing.” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

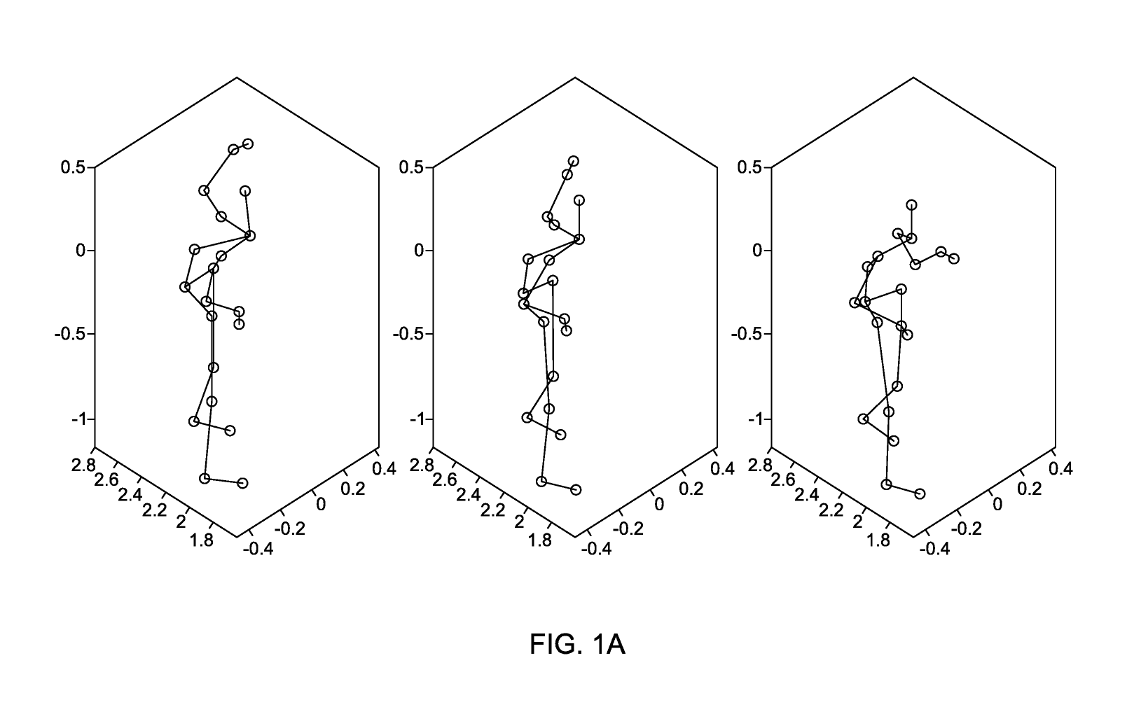

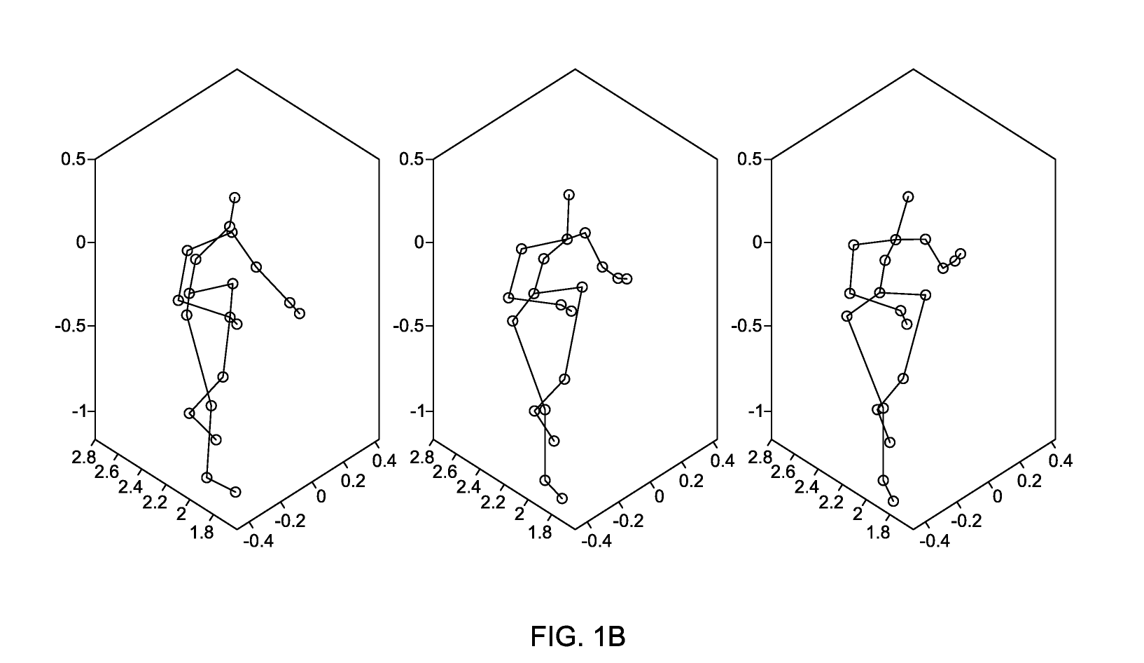

FIG. 1a and FIG. 1b illustrates a skeleton tracked using a depth sensing device such as Kinect™ by Microsoft corporation and associated software development kit for sensing a tennis swing action. The depth sensing device tracks the various joint movements or body part movements of an entity such as a human being or robot. Each joint between two body parts or limbs is associated with a descriptor that is tracked by means of a plurality of sensors that track the action in a 3D coordinate system. Apart from the 3D coordinate system the depth may also be sensed. An action such a tennis swing involves movement of various body parts that are shown by the lines joined between two or more joints. The joints move in relation with each other as the body parts move to complete the action. The depth sensing device captures the action frame by frame that are shown in the figure. One or more joints may have a different position in each frame.

Studies on biomechanics have found that human body movements follow patterns of interaction, and coordination between limbs or segments that fall on a continuum ranging from simultaneous actions to sequential actions. The majority of human body motion can be fully characterized with angular kinematics using angles between body segments. The present disclosure proposes spatial temporal descriptors computed from joint positions to encode both simultaneous and sequential, interactions of human body movements for motion analysis, including action recognition and gait biometrics. These descriptors are invariant to viewing geometry, and preserve the dynamics and interactions, allowing them to be discriminative.

Given a sequence of N frame {f⁰, f¹, f² , . . . , f^{N-3}} where the i^{th} frame f={ v̅₀ⁱ, v̅₁ⁱ, v̅₂ⁱ, . . . , v̅ⱼ₋₃ⁱ} contains J tracked 3D joints where v̅ⱼⁱ=[xⱼⁱ, yⱼⁱ, zⱼⁱ]′, the posture interaction descriptors are defined to encode the interactions between static postures, and the motion dynamics descriptors are defined to capture dynamics in joint motion.

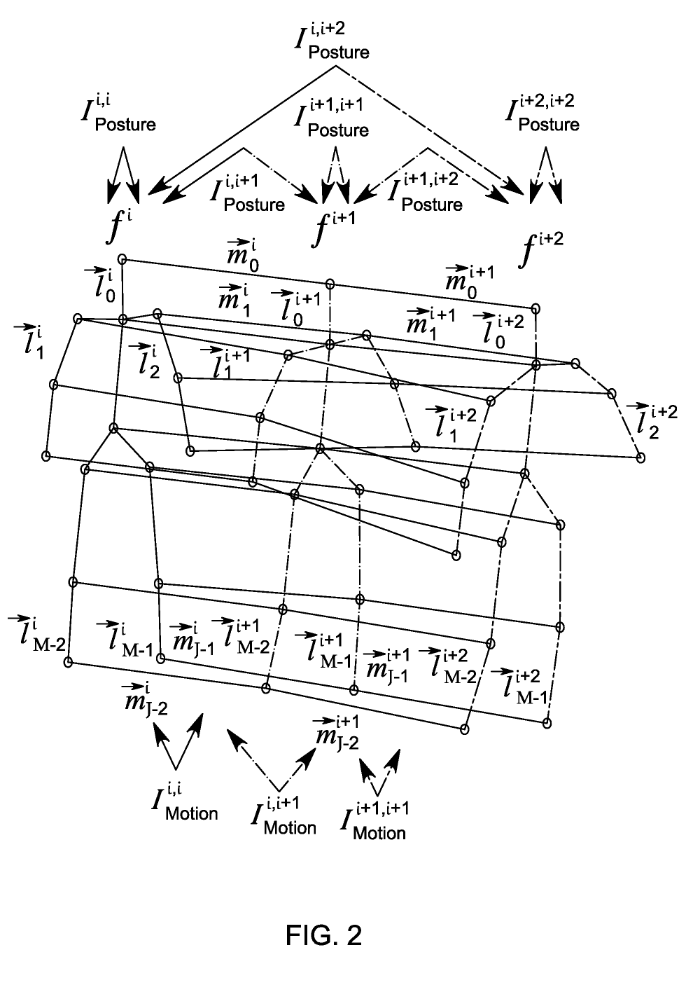

FIG. 2 is a schematic drawing showing invariant spatial temporal interactions from a tracked skeleton. A simplified skeleton is tracked in three consecutive frames f⁰ f⁺¹, and f⁺². The proposed descriptors capture both within-frame simultaneous interactions and between-frame sequential dynamics. As shown in the figure, posture interaction descriptors (I_{Posture}ⁱ) capture the important contextual information between limbs within and across frames that could be critical in characterizing an action. The motion dynamics descriptors (Iₘₒₜᵢₒₙⁱ) are also invariant to the viewing geometry by definition.

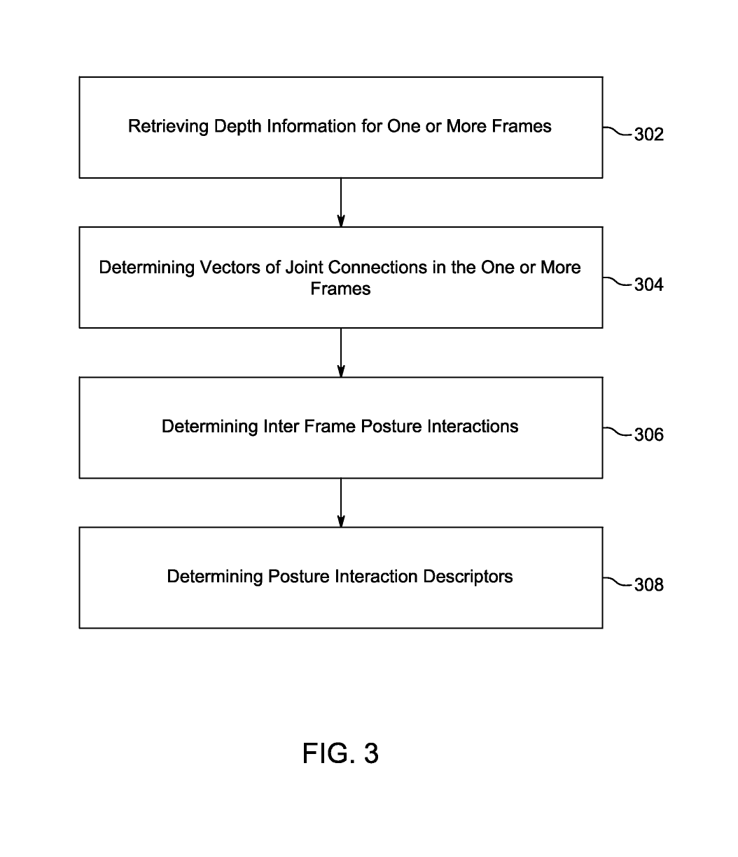

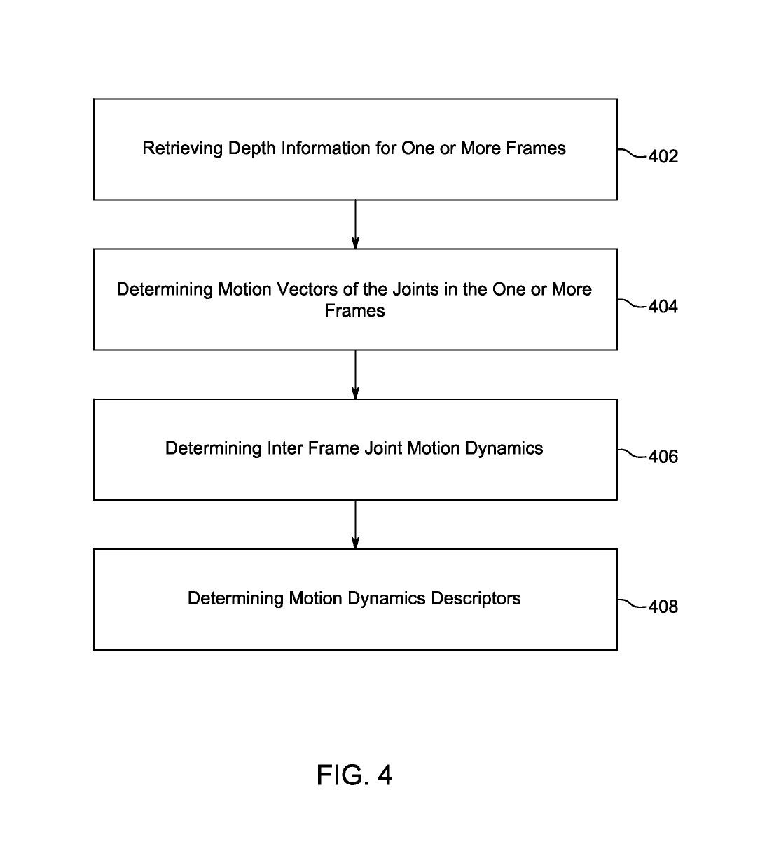

As shown in FIG. 2, the posture interaction descriptors and motion dynamics descriptors encode complementary body interactions and dynamics for an action sequence. The posture interaction descriptors and the motion dynamics descriptors are combined to provide a highly representative and discriminative representation for robust action detection and recognition as described in FIG. 3 and FIG. 4.

These descriptors encode line details of both motion dynamics and posture interactions, allowing the descriptors to be highly representative and discriminative. We propose spatial temporal descriptors computed from joint positions to encode both simultaneous and sequential interactions of human body movements for action recognition. As the cosine similarity between two limb vectors only depends on their intersection angle, the posture interaction descriptors are invariant to the viewing geometry. The similarity measurements from both descriptor types are then summed up as the similarity between two instantaneous actionlets. The descriptors can be combined with additional cues such as “depth appearance” or advanced machine learning techniques to further improve the recognition accuracy.

FIG. 3 shows a flow diagram of a method for determining view invariant spatial-temporal posture interaction descriptors, according to an embodiment. Posture interaction descriptors capture the view invariant spatial-temporal relationships between postures within a frame and across frames.

At step 302, depth information for one or more frames is retrieved. In an aspect, the depth information may be either stored in a storage memory such as a database or a hard disk, and the like. In another aspect, the depth information may be captured in real time by one or more sensors adapted for determining depth such as sensors of Kinect™. The depth information may comprise of the positional information of various joints of an entity over a time frame. The positional information of each joint may or may not change over the time frame.

At step 304, vectors of joint connections are determined in the one or more frames. For example, there may be a total M number of joints wherein each joint is connected with one or more joints for making a limb or body section. The joint connections in the ith frame may be represented by Lⁱ, where Lⁱ={Ī₀ⁱ, Ī₁ⁱ, Ī₂ⁱ, . . . wherein Īⱼⁱ= v̅ⱼ₁ⁱ− v̅ⱼ₂ⁱ is the 3D displacement vector for the limb/body section with end joints v̅ⱼ₁ⁱ and v̅₂ⁱ respectively.

At step 306, inter frame posture interactions are determined. The inter-frame posture interactions (I_{Posture}^{i,j}) between two frames, for example fⁱ and f^{j} is determined in terms of the cosine similarity between all the limb/body segments having M joints:

$${I}_{Posture}^{′ , j} = [ \begin{matrix}S ( {\overline{l}}_{0}^{i} , {\overline{l}}_{0}^{j} ) & S ( {\overline{l}}_{0}^{i} , {\overline{l}}_{1}^{j} ) & … & S ( {\overline{l}}_{0}^{i} , {\overline{l}}_{M - 2}^{j} ) & S ( {\overline{l}}_{0}^{i} , {\overline{l}}_{M - 1}^{j} ) \\ S ( {\overline{l}}_{1}^{i} , {\overline{l}}_{0}^{j} ) & S ( {\overline{l}}_{1}^{i} , {\overline{l}}_{1}^{j} ) & … & S ( {\overline{l}}_{1}^{i} , {\overline{l}}_{M - 2}^{j} ) & S ( {\overline{l}}_{1}^{i} , {\overline{l}}_{M - 1}^{j} ) \\ ⋮ & ⋮ & & ⋮ & ⋮ \\ S ( {\overline{l}}_{M - 2}^{i} , {\overline{l}}_{0}^{j} ) & S ( {\overline{l}}_{M - 2}^{i} , {\overline{l}}_{1}^{j} ) & … & S ( {\overline{l}}_{M - 2}^{i} , {\overline{l}}_{M - 2}^{j} ) & S ( {\overline{l}}_{M - 2}^{i} , {\overline{l}}_{M - 1}^{j} ) \\ S ( {\overline{l}}_{M - 1}^{i} , {\overline{l}}_{0}^{j} ) & S ( {\overline{l}}_{M - 1}^{i} , {\overline{l}}_{1}^{j} ) & … & S ( {\overline{l}}_{M - 1}^{i} , {\overline{l}}_{M - 2}^{j} ) & S ( {\overline{l}}_{M - 1}^{i} , {\overline{l}}_{M - 1}^{j} )\end{matrix} ]$$

where S is a similarity measure.

At step 308, finally the posture interaction descriptors are determined. Cosine similarity for the interaction between a k^{th} limb/body segment in the i^{th} frame and a n^{th} limb/body segment in the j^{th} frame is determined according the equation:

$$S ( {\overline{l}}_{k}^{i} , {\overline{l}}_{n}^{j} ) = \frac{{\overline{l}}_{k}^{i} \cdot {\overline{l}}_{n}^{j}}{‖ {\overline{l}}_{k}^{i} ‖ ‖ {\overline{l}}_{n}^{j} ‖}$$

At time i, the posture dynamics descriptor I_{Posture}ⁱ consists of the current and time lagged posture interactions up to a prespecified time lag L:

I_{Posture}ⁱ=[I_{Posture}^{i,j} I_{Posture}^{i,j+1} . . . I_{Posture}^{i,j+L-1} I_{Posture}^{i,j+L}]′

The set of posture interaction descriptors for an action sequence is equal to:

{I_{Posture}⁰, I_{Posture}¹, I_{Posture}², . . . I_{Posture}^{N-L-2}, I_{Posture}^{N-L-1}}

As the cosine similarity between two limb vectors only depends on their intersection angle, the posture interaction descriptors are invariant to the viewing geometry. In addition, they capture the dynamics of body interactions allowing them to be highly representative and discriminative. FIG. 2 illustrates the construction of posture interaction descriptors using tracked limb/body segments in action sequences. As shown in the figure, posture interaction descriptors capture the important contextual information between limbs within and across frames that could be critical in characterizing an action.

FIG. 4 shows a flow diagram of a method for determining view invariant spatial-temporal motion dynamics descriptors, according to an embodiment.

At step 402, depth information for one or more frames is retrieved, in an aspect, the depth, information may be either stored in a storage memory such as a database or a hard disk, and the like. In another aspect, the depth information may be captured in real time by one or more sensors adapted for determining depth such as sensors of Kinect™. The depth information may comprise of the positional information of various joints of an entity over a time frame. The positional information of each joint may or may not change over the time frame.

At step 404, motion vectors of the joints in the one or more frames are determined. Motion dynamics descriptors capture the view invariant spatial temporal interactions between motions of the limbs/body sections across frames. For a set of J tracked joints motion vectors may be defined as f¹={ v̅₁ⁱ, v̅₁ⁱ, v̅₂ⁱ, . . . v̅ⱼⁱ} at time i, inter-frame 3D joint motion may be defined as { m̅₀ⁱ, m̅₁ⁱ, m̅₂ⁱ, . . . m̅₃₋₁ⁱ, where m̅ₖⁱ= v̅ₖⁱ− v̅ₖ^{j+1} is the 3D motion, vector of the k^{th} joint between the i^{th} and i+I^{th} frames.

At step 406, inter frame joint motion dynamics are determined. The inter-frame joint motion dynamics between frames two frames fⁱ and f^{j} is defined in terms of the cosine similarities between joint motion pairs:

$${I}_{Motion}^{i , j} = [ \begin{matrix}S ( {\overline{m}}_{0}^{i} , {\overline{m}}_{0}^{j} ) & S ( {\overline{m}}_{0}^{i} , {\overline{m}}_{1}^{j} ) & □ & S ( {\overline{m}}_{0}^{i} , {\overline{m}}_{J - 2}^{j} ) & S ( {\overline{m}}_{0}^{i} , {\overline{m}}_{J - 1}^{j} ) \\ S ( {\overline{m}}_{1}^{i} , {\overline{m}}_{0}^{j} ) & S ( {\overline{m}}_{1}^{i} , {\overline{m}}_{1}^{j} ) & □ & S ( {\overline{m}}_{1}^{i} , {\overline{m}}_{J - 2}^{j} ) & S ( {\overline{m}}_{1}^{i} , {\overline{m}}_{J - 1}^{j} ) \\ □ & □ & □ & □ & □ \\ S ( {\overline{m}}_{J - 2}^{i} , {\overline{m}}_{0}^{j} ) & S ( {\overline{m}}_{J - 2}^{i} , {\overline{m}}_{1}^{j} ) & □ & S ( {\overline{m}}_{J - 2}^{i} , {\overline{m}}_{J - 2}^{j} ) & S ( {\overline{m}}_{J - 2}^{i} , {\overline{m}}_{J - 1}^{j} ) \\ S ( {\overline{m}}_{J - 1}^{i} , {\overline{m}}_{0}^{j} ) & S ( {\overline{m}}_{J - 1}^{i} , {\overline{m}}_{1}^{j} ) & □ & S ( {\overline{m}}_{J - 1}^{i} , {\overline{m}}_{J - 2}^{j} ) & S ( {\overline{m}}_{J - 1}^{i} , {\overline{m}}_{J - 1}^{j} )\end{matrix} ]$$

$$where , S ( {\overline{m}}_{k}^{i} , {\overline{m}}_{n}^{j} ) = \frac{{\overline{m}}_{k}^{i} \cdot {\overline{m}}_{n}^{j}}{‖ {\overline{m}}_{k}^{i} ‖ ‖ {\overline{m}}_{n}^{j} ‖} .$$

At step 408, finally the motion dynamics descriptors are determined. The motion dynamics descriptor at time i consists of the current and time lagged joint motion interactions up to time lag L is defined as:

I_{Motion}ⁱ=[I_{Motion}^{i,i} I_{Motion}^{i,i+1} . . . I_{Motion}^{i,i+L-1} I_{Motion}^{i,i+L}]¹

These interactions are illustrated in FIG. 2 as well. The motion dynamics descriptors are also invariant to the viewing geometry by definition. The motion dynamics for an action sequence are characterized using the set of motion dynamics descriptors computed over time and may be represented as:

{I_{Motion}⁰, I_{Motion}¹, I_{Motion}², . . . I_{Motion}^{N-L-2}, I_{Motion}^{N-L-1}}

Feature matching and classification

For each tracked skeleton in the action sequence, a posture interaction descriptor and a motion dynamics descriptor is extracted to encode the context and dynamics information in the local temporal neighborhood. In an aspect, normalized correlation is used to compute the similarity between the two descriptors. The similarity measurements from both descriptors are men summed up as the similarity between two instantaneous actionlets.

We have adopted the Naïve Bayesian Nearest Neighbor classifier for its simplicity and effectiveness. To match two action sequences, we compute for every feature vector in one action sequence, its nearest neighbor in the other action sequence and sum up the similarities using normalized correlation. The mean similarity measurement is used as the similarity between the two sequences. Each test action sequence is then assigned the label of the best matched training action sequence:

$$\overline{C} = {argmax}_{c} {\sum }_{i = 0}^{{N}_{test} - L - 1 {N}_{train} - L - 1} {max}_{j = 0} ( NC ( {d}_{i}^{test} , {d}_{j}^{train} ) ) / ( {N}_{test} - L - 1 )$$

where NC(d^{test}, dⱼ^{train}) is the normalized correlation between the ith descriptor feature of the test sequence and thejth descriptor feature in the training sequence, Nₜₑₛₜ and Nₜᵣₐᵢₙ are the number of frames for the testing and training sequence respectively, and L is the time lag.

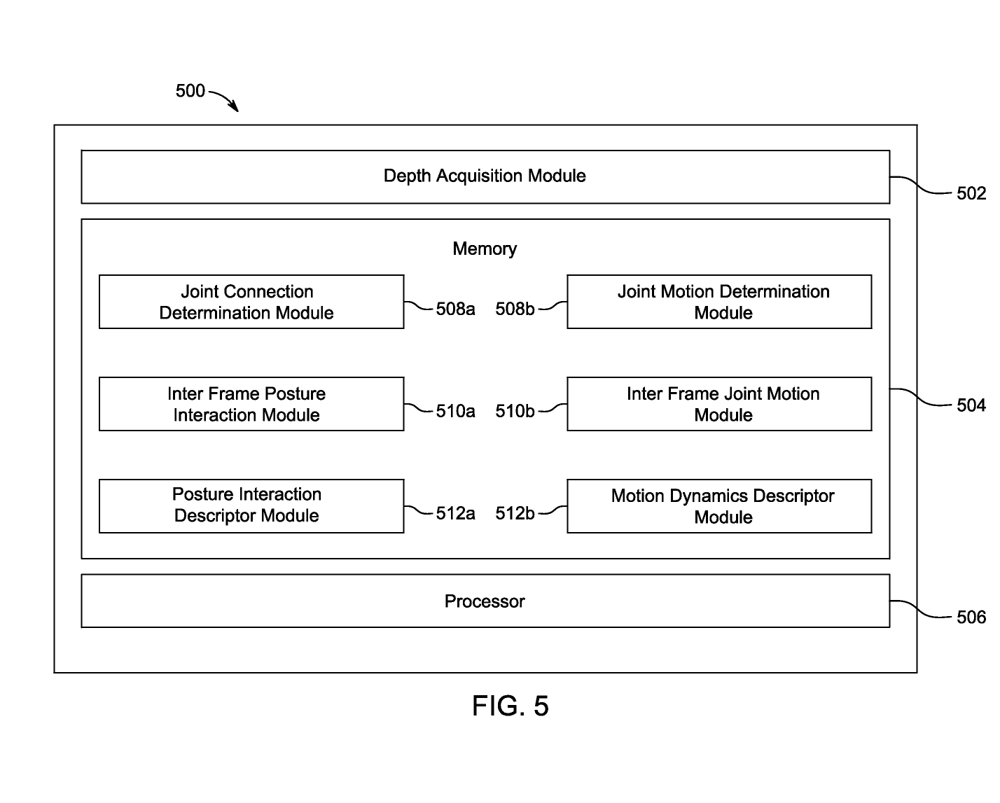

FIG. 5 illustrates a block diagram of a system 500 for determining view invariant spatial-temporal descriptors, according to an embodiment. The system 500 at least comprises of a depth acquisition module 502, a memory 504, and a processor 506. The system 500 may also comprise of an output module such as a display screen and may be connected to a database or certain storage means. The system 500 may either include or may be connected to one or more depth sensors such as the sensors of Kinect™ or any other device having depth sensors for capturing depth information related to an entity. The depth information may also be rendered in form of a skeleton. The processor 506 may be a single processor or a group of processor adapted for executing one or more instructions stored in the memory 504. The memory 504 comprises of a plurality of modules including joint connection determination module 508a, inter frame posture interaction module 510a, and posture interaction descriptor module 512a. The joint connection determination module 508a enables determining the vectors of joint connections in one or more frames. The Inter frame posture interaction module 510a enables determining the inter frame posture interactions. The posture interaction, descriptor module 512a enables determining the posture interaction descriptors.

The memory 504 also includes joint motion determination module 508b, inter frame joint motion module 510b, and motion dynamics descriptor module 512b. The joint motion determination module 508b enables determining motion, vectors of the joints in one or more frames. The inter frame joint motion module 510b enables determining inter frame joint motion dynamics. The motion dynamics descriptor module 512b enables determining motion dynamics descriptors. The various modules stored in the memory 504 include program instructions that are executed by the processor 506 to follow the method steps as described above.

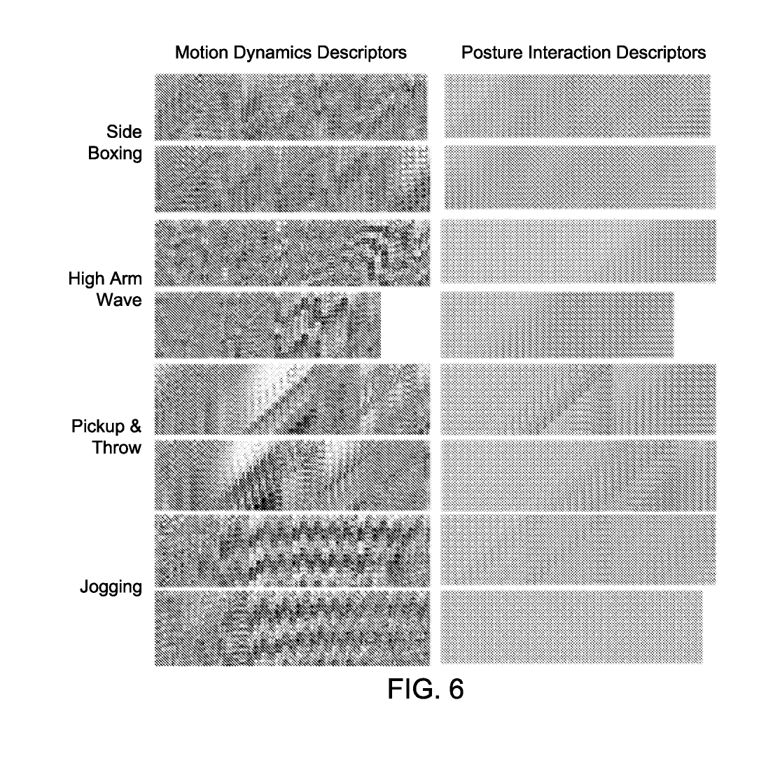

FIG. 6 is a visualization of the motion dynamics descriptors and posture interaction descriptors for skeleton action sequences from the Microsoft Research Action3D dataset. Features from two different subjects for four action classes are presented. Descriptors at a given time are unfolded and flattened in time lag along the vertical axis to form an image slice of sizes and for posture interaction descriptors and motion dynamics descriptors respectively. Descriptors across the whole sequence are eollaged horizontally to form the visualized images of size and respectively. For every action class, the descriptor features are visualized from two different subjects. There is good consistency in the patterns for the same action class even with different subjects, yet quite distinguishing patterns for separate action classes. Visually, the two descriptors appear to capture distinct aspects of the action. Together, Posture interaction descriptors and motion dynamics descriptors combined capture the full dynamics of the body interactions and movements to be highly representative and discriminative.

In an aspect, posture interactions are captured using the cosine similarities between limbs or body sections of an entity. In addition, the motion dynamics are captured using cosine similarities between movements of different joints. The features captured by means of cosine similarities are view invariant by design. While existing technologies compute joint angle features from one or two separate frames, the present disclosure describes computing these invariant interactions between frames within a range of time lags.

In an aspect, the system and method described in the present disclosure capture the temporal dynamics and spatial-temporal context. In another aspect, the system and method described in the present disclosure preserve the governing higher order differential properties of the multivariate joint time series for improved discrimination.

The view invariant spatial-temporal descriptors for skeleton encode fine details of both motion dynamics and posture interactions, allowing them to be highly representative and discriminative. The spatial-temporal descriptors computed from joint positions encode both simultaneous and sequential interactions of human body movements for action recognition. As the cosine similarity between two limb vectors only depends on their intersection angle, the posture interaction descriptors are invariant to the viewing geometry. The similarity measurements from both descriptor types are then summed up as the similarity between two instantaneous actionlets. The descriptors can be combined with additional cues such as “depth appearance” or advanced machine learning techniques to further improve the recognition accuracy.

The performance of the new descriptors has been evaluated, using the Microsoft Research Action3D dataset as is described in W. Li, Z. Zhang, and Z. Liu in. “Action Recognition Based on a Bag of 3D Points”; CVPRW, 2010 and compare it to those of the state of the art action recognition algorithms. The performance study confirms the advantageous view invariance and high discriminating power of the proposed descriptors which outperform existing joint based action recognition algorithms.

The performance of the proposed approach is evaluated on the popular Microsoft Research Action3D dataset. The goal is to investigate the effectiveness of the proposed descriptors for action recognition. With this consideration, the simple Naïve Bayesian Nearest Neighbor classifier is used is described in O. Boiman, E. Shechtman, and M. Irani, “In Defense of Nearest-Neighbor Based Image Classification,” Computer Vision and Pattern Recognition, 2008 and only use joint location information as input in the experiments. The resulting performance is compared with those of published algorithms that also only use joint location information as input. It is noted that the descriptors determined according to the present method and system can be combined with additional cues such as “depth appearance” or advanced machine learning techniques to further improve the recognition accuracy.

Microsoft Research Action3D dataset is one of the first public Kinect™ Action datasets and has been commonly used for action algorithm performance benchmarking.It contains 20 action types, 10 subjects, with two to three repetitions from each subject. There are a total of 567 depth sequences with a frame rate at 15 HZ. A skeleton model of 20 joints is tracked for each sequence and the tracking results are available with the dataset. We use these joint data to evaluate our algorithms.

TABLE 1
The three subsets of actions used in the experiments

| Action Set 1 | Action Set 2 | Action Set 3 |
|---|---|---|
| Horizontal arm wave | High arm wave Hand catch | High throw |
| Hammer | Draw X | Forward kick |
| Forward punch | Draw tick | Side kick |
| High throw | Draw circle | Jogging |
| Hand clap | Two hand wave | Tennis swing |
| Bend | Forward kick | Tennis serve |
| Tennis serve | Side boxing | Golf swing |
| Pickup & throw | | Pickup & throw |

Most publications adopt the experimental setting used in the original publication for the dataset: the 20 actions are divided into three subsets, each containing eight actions (see Table 1). We use cross-subject tests for our evaluation: subjects 1, 3, 5, 7, and 9 are used for training and the remaining subjects are used for testing.

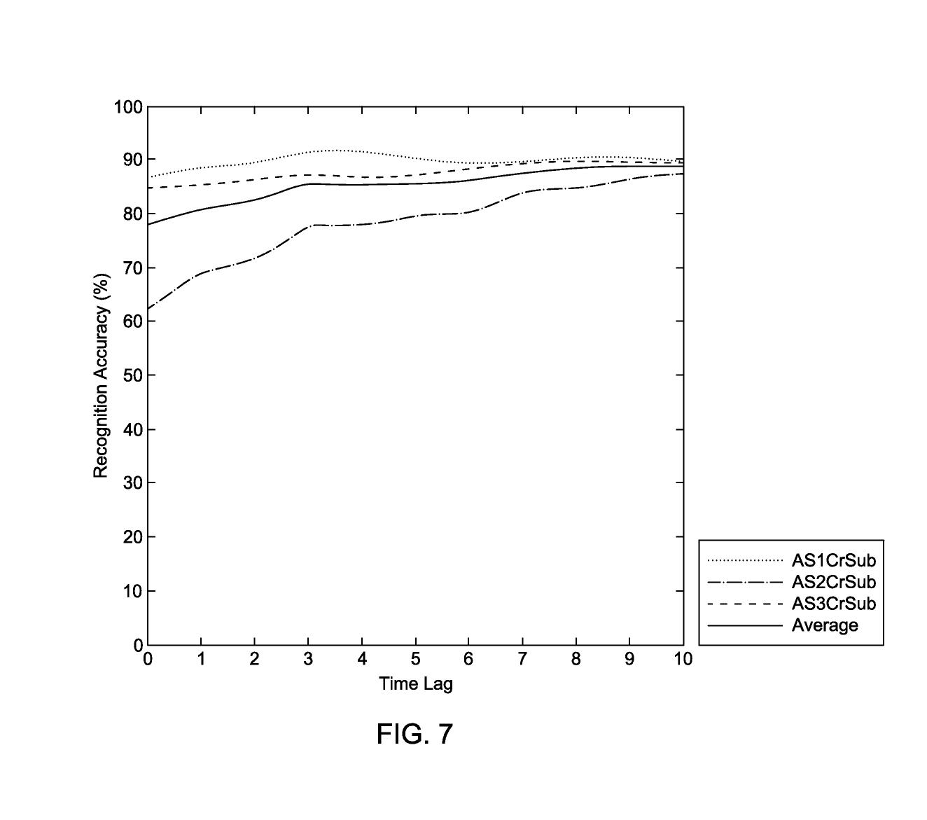

The lag parameter L runs from 0 to 10, and the recognition accuracies for the three cross subject tests is recorded. These results, together with the average accuracy for the three tests, are shown in FIG. 7. FIG. 7 is a graph showing a cross-subject action recognition accuracy of the proposed algorithm on the Microsoft Research Action3D dataset. These accuracies in general increase with the lag length, up to L=10, and then start, to decrease slightly, indicating that the temporal interactions and dynamics at certain scale help discriminating actions.

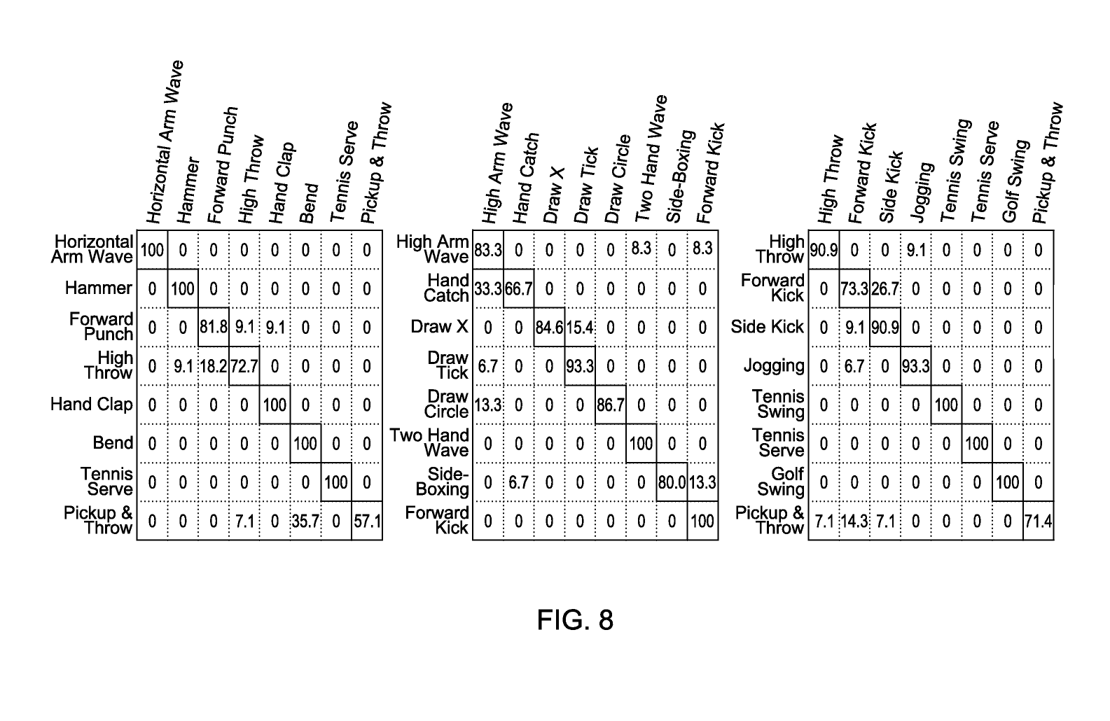

FIG. 8 shows confusion matrices (in percent) for the three cross-subject action recognition tests on the Microsoft Research Action3D dataset. Rows correspond to ground truth labels and columns correspond to recognized labels. FIG. 8 shows the confusion matrix for each of the three subtests at time lag L=10. Cross-subject classifications are usually challenging as we need to overcome the between subject variations to derive the correct action category. The algorithm is doing reasonably well and making understandable mistakes. For example, it tends to confuse high arm wave for hand catch as both descriptors with time lagged interactions and dynamics are used, indicating the beneficial contribution from each component.

Performances of state-of-the-art action recognition algorithms are also included on this dataset in the table for benchmarking purposes. For a fair comparison, the performance results that rely only on the joint positions are only included. With the same skeleton position input, the proposed algorithm outperforms other existing skeleton based action recognition algorithms, thanks to the combined benefit of both view invariance and fine dynamic interactions in both motion and posture.

It may be noted that better performance has been reported on this dataset when additional cues such as surface points or appearances are used. Note that the proposed algorithm solely exploits the joint location data, and its performance is obviously influenced by the quality of the tracked skeletons that are used. Although the Kinect SDK has made great strides in real-time skeleton tracking, there are still lots of rooms for performance improvement in the presence of occlusions, fast motions, and the like. Even though the tracked skeletons are in general acceptable, there are still quite some noisy and erroneous detection in the data. Some existing studies exclude sequences with missing or corrupted skeletons in their performance evaluations. We still use all 567 action sequences to be consistent with majority of existing studies. However, we would like to point out that the use of other features directly extracted from the raw depth images can help avoid these tracking errors for better performance.

The skeleton based spatial-temporal descriptors for action recognition and activity analysis are view invariant by design. Furthermore, they capture the complex motion dynamics and posture context enabling them to be highly discriminative.

The action recognition performance of the proposed algorithm is evaluated on the Microsoft Research Action3D dataset. The proposed spatial-temporal descriptors have demonstrated superior performance compared to action recognition algorithms using other skeleton features. As view invariant spatial-temporal descriptors that capture fine scale interactions and dynamics, the proposed descriptors can also be used for action detection, segmentation, and the like.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical

TABLE 2

| | Accuracy | | | |
|---|---|---|---|---|
| Method | AS1CrSub | AS2CrSub | AS3CrSub | Overall |
| Histogram of Joints3D | 87.98 | 85.48 | 63.46 | 78.97 |
| Eigen Joints | 74.5 | 76.1 | 96.4 | 82.1 |
| Joint Angle Similarity | NA | NA | NA | 83.53 |
| (JAS(Cosine) + MaxMin) | | | | |
| Motion dynamics | 77.14 | 63.39 | 85.59 | 75.37 |
| descriptors (L = 10) | | | | |
| Posture interaction | 81.91 | 80.36 | 82.88 | 81.72 |
| descriptors (L = 10) | | | | |
| Motion dynamics | 86.67 | 62.50 | 84.68 | 77.95 |
| descriptors + | | | | |
| Posture interaction | | | | |
| descriptors (L = 0) | | | | |
| Motion dynamics | 89.52 | 87.50 | 90.09 | 89.04 |
| descriptors + | | | | |
| Posture interaction | | | | |
| descriptors (L = 10) | | | | |

disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

Moreover, although the present disclosure and its advantages have been described in detail, it should be understood that various changes, substitutions and alterations can be made herein without departing from the disclosure as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A system for determining view invariant spatial-temporal descriptors comprising:
a depth acquisition module for retrieving depth information related to a plurality of joints over a time period, wherein at least a pair of joints amongst the plurality of joints constitute a limb;
at least one processor; and
a memory comprising one or more modules adapted to be executed by the at least one processor, wherein the processor upon executing the modules is configured for determining posture interactions descriptors and motion dynamics descriptors for the depth information retrieved by the depth acquisition module, wherein the posture interactions descriptors are determined based on cosine similarities between one or more limbs, arid the motion dynamics descriptors is determined based on cosine similarities between movements of the plurality of joints.

2. The system as claimed in claim 1, wherein the system comprises of a depth defection device.

3. A method for determining view invariant spatial-temporal descriptors, wherein the method comprises of:
retrieving depth information related to a plurality of joints over a time period, wherein at least a pair of joints amongst the plurality of joints constitute a limb; and
determining posture interactions descriptors and motion dynamics descriptors, wherein the posture interactions descriptors are determined based on cosine similarities between one or more limbs, and the motion dynamics descriptors is determined based on cosine similarities between movements of the plurality of joints.

4. A computer program product tangibly embodied on a computer-readable storage medium and including executable code that causes at least one data processing apparatus to:
retrieve depth information related to a plurality of joints over a time period, wherein at least a pair of joints amongst the plurality of joints constitute a limb; and
determine posture interactions descriptors and motion dynamics descriptors, wherein the posture interactions descriptors are determined based on cosine similarities between one or more limbs, and the motion dynamics descriptors is determined based on cosine similarities between movements of the plurality of joints.

5. The system as claimed in claim 1, wherein the memory comprises a joint connection determination module, an inter frame posture interaction module, a posture interaction descriptor module, a joint motion determination module, an inter frame joint motion module, and a motion dynamics descriptor module.
